(19) United States
(12) Patent Application Publication
(10) Pub. No.: US 2023/0181952 A1
(43) Pub. Date: Jun. 15, 2023

(54) CONSTANT PRESSURE VALVE, AND ALARM VALVE STATION AND SPRINKLER SYSTEM COMPRISING SAME

(71) Applicant: MINIMAX GMBH & CO. KG, Bad Oldesloe (DE)

(72) Inventor: Chrysafis ZLATINTSIS, Neumünster (DE)

(21) Appl. No.: 16/476,992

(22) PCT Filed: Jan. 12, 2018
(86) PCT No.: PCT/EP2018/050749

§ 371 Date: Aug. 29, 2019

(30) Foreign Application Priority Data
Jan. 12, 2017 (DE) 10 2017 100 505.6

(51) Int. Cl. A62C 35/60; A62C 35/68; F16K 31/00; F16K 31/165

(52) U.S. Cl. CPC A62C 35/605; A62C 35/68; F16K 31/003; F16K 31/165

(57) ABSTRACT

The invention relates to a constant-pressure valve (45), in particular for an alarm valve station (100) of a sprinkler system (200), having a fluid inlet (16), a fluid outlet (15), a flow channel between the fluid inlet and the fluid outlet, and a control piston (3, 8) which is arranged in the flow channel and which is movable back and forth between a standby position and a triggering position and which has a first piston surface (S₁) facing toward the flow channel and has a second piston surface (S₂).

It is proposed according to the invention that the constant-pressure valve has a switching chamber which is separate from the flow channel and which has a switching pressure inlet (4) in fluid communication with the switching chamber, wherein the second piston surface (S₂) faces toward the switching chamber (4a), wherein the constant-pressure valve (45) has a securing element (21) which is coupled to the control piston (3, 8) of the constant-pressure valve (45) and which, in the standby position, absorbs the forces acting on the first piston surface (S₁) of the control piston (3, 8).

The present invention relates to a constant-pressure valve, in particular for an alarm valve station of a sprinkler system, having a fluid inlet, a fluid outlet, a flow channel between the fluid inlet and the fluid outlet, and a control piston which is arranged in the flow channel and which is movable back and forth between a standby position and a triggering position and which has a first piston surface facing toward the flow channel and has a second piston surface.

Constant-pressure valves are generally known. They are used for example in dry alarm valve stations of sprinkler systems such as to permit pneumatic triggering of the sprinkler system.

A constant-pressure valve of said type is known for example from U.S. Pat. No. 9,289,635 B2. The functional principle of the known constant-pressure valve is based substantially on the fact that the area ratio of the first piston surface in relation to the second piston surface is very small, such that, with a relatively low pressure on the side of the second piston surface, it is possible for the control piston to be held in the standby position even in the presence of high pressure on the side of the first piston surface. The flow channel on the side of the first piston surface is, in U.S. Pat. No. 9,289,635 B2, part of the flow path for the extinguishing fluid in the direction of the sprinkler of a sprinkler system. It is however also possible for the flow channel of the constant-pressure valve to be utilized as part of a control line. The control line is normally likewise charged with the fluid pressure prevailing in the main line of an extinguishing system.

A disadvantage that is associated with the functional principle of the known constant-pressure valves is its susceptibility to incorrect triggering and lack of flexibility. To prevent the likelihood of erroneous triggering in the event of an inadvertent pressure peak on the side of the first piston surface, or an unintended opening in the event of an inadvertent pressure drop on the side of the second piston surface, the second piston surface must be made very large in relation to the first piston surface. Furthermore, the valve can be implemented only for a particular range of pressure differences. This gives rise to challenges from a manufacturing aspect, and leads to associated costs. Furthermore, it has been found that, in particular in extinguishing systems which extend over multiple storeys of a building, the prevailing pressure conditions exhibit great height-related variation between the first and second piston surfaces. Accordingly, for the transport of the extinguishing fluid or fluid in the flow channel, it is additionally always also necessary for the water column that is present in the main line of the extinguishing system to be overcome. This has the result that either an individually adapted control piston must be used for each different height position of the constant-pressure valve, or individually adapted pressure values must be maintained on the side of the second piston surface, which involves very great outlay in terms of apparatus and control technology.

The invention was consequently based on the object of improving a constant-pressure valve of the type discussed in the introduction such that reliable operation, in particular in alarm valve stations or sprinkler systems, can be ensured, with simultaneously reduced outlay with regard to the manufacture of the constant-pressure valve and the switching pressure control.

The invention achieves the object on which it is based, in the case of a constant-pressure valve of the type discussed in the introduction, by virtue of the constant-pressure valve being formed with the features of claim 1.

The constant-pressure valve has a switching chamber which is separate from the flow channel and which has a switching pressure inlet in fluid communication with the switching chamber, wherein the second piston surface faces toward the switching chamber, wherein the constant-pressure valve has a securing element which is coupled to the control piston of the constant-pressure valve and which, in the standby position, absorbs the forces acting on the first piston surface of the control piston. Here, the invention follows the principle that, by means of the securing element, a direct interaction between the pressure acting on the first piston surface and the switching pressure acting on the second piston surface is, in the standby position of the control piston, eliminated in that the pressure in the switching chamber acts on the control piston in the direction of the standby position, but conversely, by means of the securing element, the forces in the triggering direction caused by the pressure on the first piston surface are decoupled therefrom and absorbed. This has the result that the constant-pressure valve holds the control piston in the standby position for as long as the pressure at the switching pressure inlet lies above a predetermined switching pressure value, independently of the pressure on the side of the first piston surface of the control piston. Erroneous triggering owing to pressure fluctuations on the side of the first piston surface is hereby eliminated entirely. It is advantageous for the second piston surface to be formed so as to be larger than the first piston surface. The greater this size ratio is configured to be, the lower is the switching pressure that is required on the side of the switching pressure inlet of the switching chamber such as to maintain the standby position. However, in relation to the prior art, it is possible for relatively small ratios to be provided because forces acting on the side of the first piston surface no longer have a significant influence on the opening characteristics of the control piston.

The invention is advantageously refined by virtue of the securing element being configured to hold the control piston of the constant-pressure valve in the standby position until the pressure acting on the second piston surface drops to the predetermined switching pressure value. The constant-pressure valve preferably has a housing in which the control piston is arranged so as to be movable in guided fashion, wherein the housing has a recess which the securing element engages in the standby position of the control piston. In this way, in the standby position, the securing element produces a positive locking action by means of which the forces acting on the first piston surface of the control piston can be reliably dissipated into the housing. To eliminate the positive locking action, and permit a movement of the control piston from the standby position into the triggering position, the securing element must merely be moved out of the recess in the housing.

In a preferred embodiment, the control piston is configured to, in the standby position, hold the securing element in the recess and, when the pressure in the pressure chamber reaches or drops below the switching pressure, permit a deflection of the securing element out of the recess.

The control piston particularly preferably has a first partial piston and a second partial piston which is longitudinally movable relative to the first partial piston, wherein the first partial piston has the first piston surface, and the second partial piston has the second piston surface. Here, “longitudinally movable” is to be understood to mean a movement of the piston in the direction of the longitudinal axis of the control piston.

The first and the second partial piston are preferably coupled such that, when the pressure in the pressure chamber exceeds the switching pressure, said partial pistons are arranged in a retracted position with respect to one another and, when the pressure in the pressure chamber reaches or drops below the switching pressure, said partial pistons are arranged in an extended position relative to one another.

It is furthermore preferable if the first partial piston has a recess in which the securing element is arranged, and the second partial piston delimits the recess of the first partial piston in the retracted position such that the securing element projects into the recess of the housing, and in the extended position permits a deflection of the securing element out of the recess. In other words, in the retracted position of the first and second partial pistons, the securing element projects partially out of the recess of the first partial piston.

It is furthermore preferable if the securing element, in the retracted position of the first and second partial pistons, is in contact with an edge of the recess of the housing, and at the point of contact has a surface normal which, relative to the longitudinal axis of the control piston, has a contact angle in a range of >0° to <45°. The angle preferably lies in a range of 10° to 20°.

As long as the surface normal is configured at an angle of greater than 0° with respect to the longitudinal axis of the control piston, the securing element slides on the edge as soon as the limitation of the movement of the securing element by the second partial piston is withdrawn. The above-described value range provides a satisfactory compromise between reliable force transmission from the securing element to the housing, on the one hand, and tolerable friction losses during the sliding on the edge, on the other hand. The securing element is preferably surface-treated, for example mechanically and/or by means of coating, such as to reduce the friction coefficient.

In a preferred embodiment, the second partial piston has a piston rod which is movable in guided fashion in a recess of the first partial piston, and also has a first axial portion with a first diameter, and a second axial portion with a second diameter which is smaller than the first diameter.

The partial pistons are preferably coupled such that the first axial portion of the piston rod is aligned with the recess of the first partial piston when the partial pistons are arranged in the retracted position relative to one another, and the second axial portion of the piston rod is aligned with the recess of the first partial piston when the partial pistons are arranged in the extended position relative to one another. Because the second axial portion has a relatively small diameter, the securing element can slide out of the recess of the housing. This sliding-out is promoted by the angled surface normal at the point of contact between securing element and housing. It is particularly preferable if, between the first and second axial portion, there is formed an axially extending transition region, for example in the form of a bevel, that is to say a frustoconically tapered profile, and/or a sequence of curvature radii. In this way, jumping of the securing element is prevented, and a relatively smooth transition of the control piston from the standby position into the triggering position is made possible.

The securing element is preferably formed as a number of balls, pins, disks or rings, and wherein, preferably, the recess in the first partial piston is formed as a corresponding number of recesses, in which the number of balls, pins, disks or rings is arranged in radially movable fashion. In this context, a number encompasses one or more elements. It is preferable if multiple securing elements are arranged so as to be distributed substantially uniformly, or uniformly, over the circumference of the control piston. The greater the selected number of securing elements, the lower is the contact pressure that acts on each individual securing element, such that the provision of a high number of securing elements permits an inexpensive material disposition with respect to the securing elements themselves.

In a particularly preferred embodiment, the securing element is formed as a multiplicity of balls which are arranged so as to slide radially in a corresponding number of bores in the first partial body.

In an advantageous refinement of the invention, the second partial piston is coupled to a pressure spring which forces the second partial piston towards the extended position. Preferably, the pressure spring is arranged so as to act between the first and second partial piston and is held in a preloaded position, in which the first and second partial pistons assume the retracted position with respect to one another, as long as the pressure acting on the second piston surface is above a predetermined switching pressure value.

The spring force of the pressure spring in the retracted position of the partial pistons is preferably substantially equal to the force that acts on the second piston surface when the pressure in the switching chamber is at the switching pressure. It is particularly preferable if, in said position, the spring force of the pressure spring is higher than the force that acts on the second piston surface when the switching pressure prevails in the switching chamber by the magnitude of the static friction between the securing element and the second partial piston when the securing element, in the retracted position of the partial pistons, is forced against the second partial piston owing to the surface normal oriented at an angle with respect to the longitudinal axis of the control piston. The magnitude of said force however is firstly low and secondly at least predeterminable by estimation, such that the dimensioning of the pressure spring in interaction with the dimensioning of the size of the second piston surface provides a very accurate definition of the required switching pressure value for the triggering of the constant-pressure valve.

The pressure spring is preferably formed as an individual spring or as a spring assembly comprising multiple spring elements, for example as a disk spring assembly comprising multiple spring elements connected in parallel or in series.

In a preferred embodiment of the constant-pressure valve, in the switching chamber there is arranged a diaphragm which is configured for sealing off the switching chamber, on the one hand, and for transmitting force to the second piston surface, on the other hand. The diaphragm is preferably clamped between two corresponding molded parts and configured to be flexible in a manner dependent on the fluid pressure prevailing in the switching chamber such as to be able to bear closely against the surface of the second piston surface of the control piston.

The invention has been described above with reference to a constant-pressure valve according to a first aspect of the invention. According to a second aspect, the invention also relates to an alarm valve station for a sprinkler system, which has a water supply line and a pressurized pipeline network with a number of sprinklers, wherein the alarm valve station has a valve, wherein the valve has an extinguishing fluid inlet, an extinguishing fluid outlet and a valve body which is movable back and forth between a shut-off position and an opened-up position.

In alternative preferred embodiments, the alarm valve is formed as a dry alarm valve or as a deluge valve. Whereas the dry alarm valve is configured specifically for use on a dry alarm valve station, the use of a combination of the deluge valve with the constant-type valve according to the invention permits the realization of a wet alarm valve station and a dry alarm valve station. In relation to the entire product family of alarm valves, the constant-type valve thus provides considerable savings potential.

The invention achieves the object mentioned in the introduction with regard to an alarm valve station in which, in particular, the constant-pressure valve according to any of the embodiments described above is formed. In particular, the constant-pressure valve has a control piston which is movable back and forth between a standby position and a triggering position, and a switching pressure inlet which, in the shut-off position of the valve body of the alarm valve, is independent of the water supply line, wherein the control piston is connected to the valve body of the alarm valve such as, in the standby position, to lock the valve body of the alarm valve in the shut-off position and to release said valve body in the triggering position, and wherein the constant-pressure valve is configured to hold the control piston in the standby position if the pressure at the switching pressure inlet lies above a predetermined switching pressure value. According to the second aspect, the invention makes use of the fact that the constant-pressure valve is used as a pilot-controlled valve such as to lock the valve body of the alarm valve in the shut-off position and such as to be able to reliably trigger said valve body independently of the fluid pressure in the water supply line. What is crucial is the activation of the control piston of the constant-pressure valve independently of the pressure of the water supply line, which constant-pressure valve is preferably designed according to any of the preferred exemplary embodiments described above.

The alarm valve station is advantageously refined such that the switching pressure inlet is configured for connection to the pressurized pipeline system, wherein the fluid pressure prevailing at the switching pressure inlet acts on the control piston of the constant-pressure valve in the direction of the standby position.

The alarm valve particularly preferably has a locking element to which the control piston is operatively coupled at least in the standby position.

The locking element is preferably formed as a locking lever which is arranged pivotably on the alarm valve and which, at least in the standby position, is mechanically connected to the valve body of the alarm valve. It is furthermore preferable if the control piston of the constant-pressure valve is a first control piston, and the locking element is furthermore coupled to a second control piston, wherein the first control piston and the second control piston are operatively coupled to one another by means of a control line. The second control piston then preferably actuates the locking element and ultimately releases the valve body of the alarm valve.

In a further preferred embodiment, the constant-pressure valve has a fluid outlet as control pressure outlet, and the control piston of the constant-pressure valve is arranged such that, in the standby position, the control pressure outlet and the control line are separated from one another, and in the triggering position, said control pressure outlet and control line are connected to one another in fluid-conducting fashion. In this advantageous embodiment, it is thus the case that, as soon as the constant-pressure valve has been moved into the triggering position, the control line is relieved of pressure, which triggers a movement of the second control piston, which then eliminates the locking of the valve body of the alarm valve and enables a release of the extinguishing medium flow to the further regions of the sprinkler system.

It is particularly preferable if a throttle is arranged in the control line upstream of the first control piston and of the second control piston. The throttle assists the pressure dissipation in the control line in the event of triggering. The second control piston, which is preferably assisted by spring force, is displaced owing to the release of pressure from the control line and unlocks the locking element, which then releases the valve body of the alarm valve.

With regard to the further advantages and preferred embodiment of the alarm valve station, reference is made to the above explanations relating to the constant-pressure valve.

In a third aspect, the invention furthermore relates to a sprinkler system, having a water supply line, a pressurized pipeline network with a number of sprinklers, and an alarm valve station with an alarm valve, which alarm valve has an extinguishing fluid inlet connected to the water supply line, an extinguishing fluid outlet connected to the pressurized pipeline network, and a valve body which is movable back and forth between a shut-off position and an opened-up position, wherein, in the shut-off position, the extinguishing fluid inlet and the extinguishing fluid outlet are separated from one another, and in the opened-up position, the extinguishing fluid inlet and the extinguisher fluid outlet communicate with one another.

In the case of a sprinkler system of said type, the invention achieves the object mentioned in the introduction by virtue of the alarm valve station being designed according to any of the preferred embodiments described above.

The preferred embodiments and advantages of the constant-pressure valve according to the first aspect of the invention and the embodiment and advantages relating to the alarm valve station according to the second aspect are simultaneously advantages and preferred embodiments of the sprinkler system according to the third aspect.

The invention will be described in more detail below with reference to the appended figures, in which:

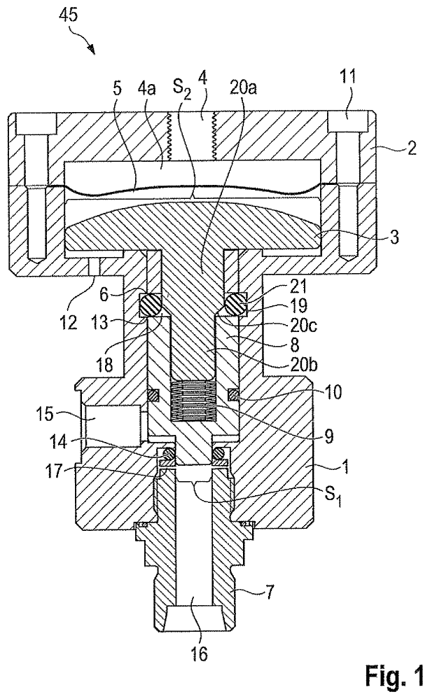

FIG. 1 is a schematic cross-sectional illustration through a constant-pressure valve according to a preferred exemplary embodiment of the invention,

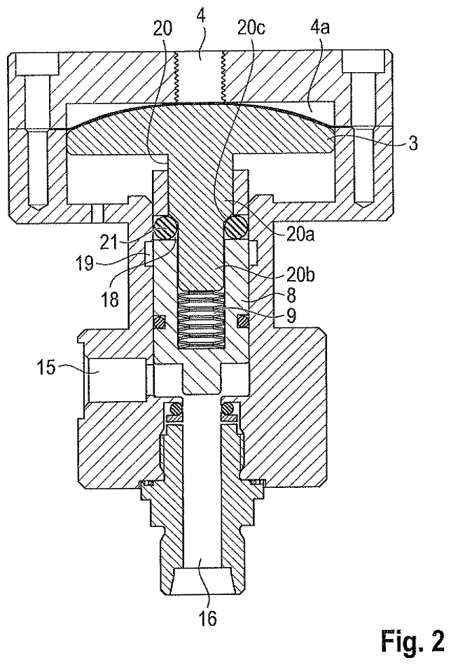

FIG. 2 shows a view of the constant-pressure valve according to FIG. 1 in an alternative operating state,

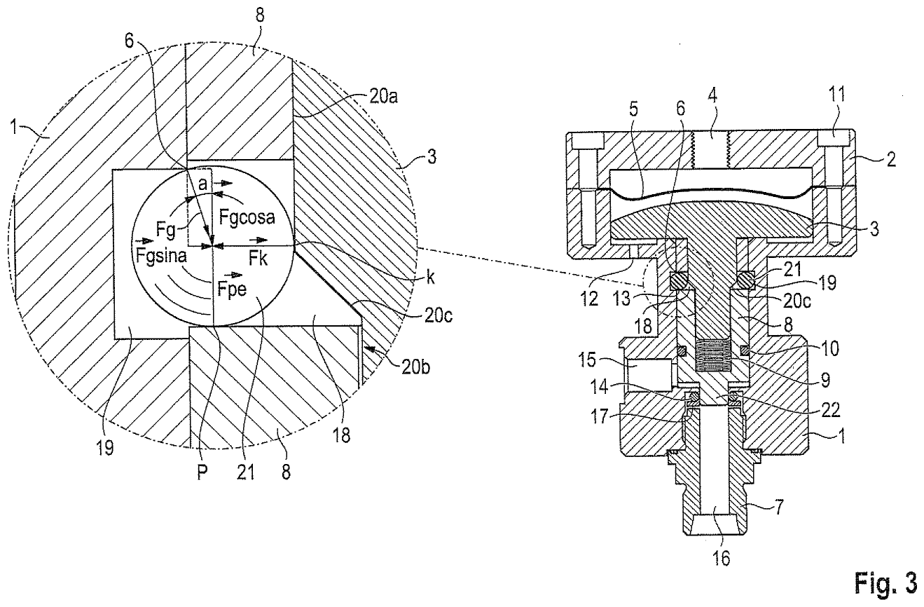

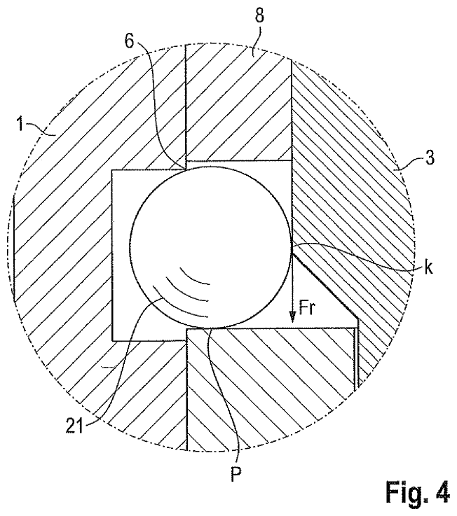

FIGS. 3-4 show detail views of the constant-pressure valve according to FIG. 1, and

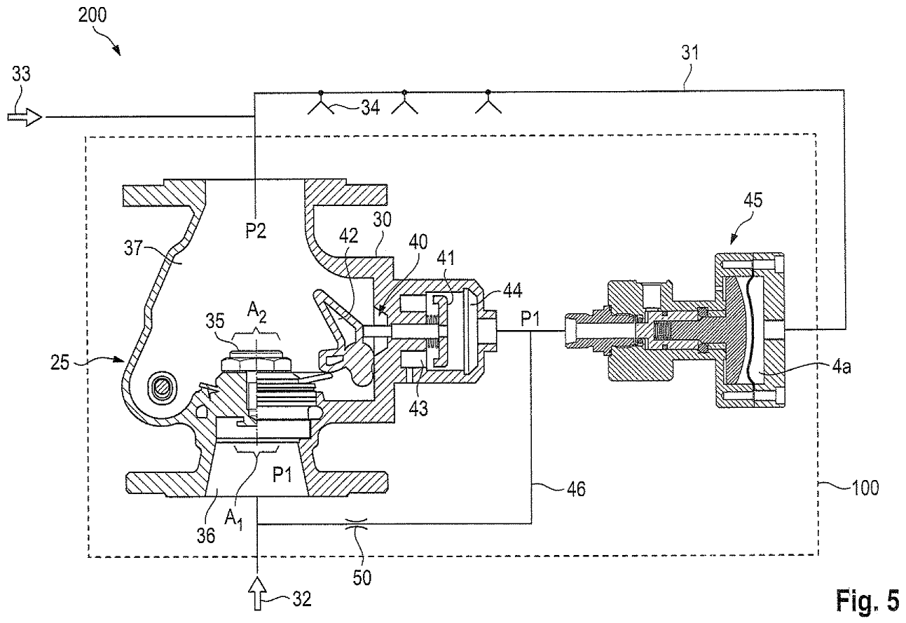

FIG. 5 shows a schematic cross-sectional view of an alarm valve station and sprinkler system according to a preferred exemplary embodiment.

The constant-pressure valve 45 shown in FIG. 1 has a housing 1 which is closed off by a cover 2. A control piston is arranged so as to be guided in longitudinally movable fashion in the interior of the housing 1. The control piston has a first partial piston 8 and a second partial piston 3. The first partial piston 8 has a first piston surface S₁. The second partial piston 3 has a second piston surface S₂. Between the cover 2 and the housing 1, there is formed a switching chamber 4a which can be charged with fluid pressure, preferably pneumatically, by means of a switching pressure inlet 4.

A diaphragm 5 is also arranged in the switching chamber 4a. The diaphragm 5 is configured for sealing off the switching chamber 4a and at any rate partially bearing closely against the second piston surface S₂ of the second partial piston 3 under pressure loading.

The constant-pressure valve 45 has a fluid inlet 16 and a fluid outlet 15. Optionally, the fluid inlet 16 is formed on an inlet connector 7 which is screwed into the body of the housing 1.

The control piston 3, 8 is shown in FIG. 1 in a standby position. In the standby position shown, the first piston surface Si closes off the flow channel between fluid inlet 16 and fluid outlet 15 at a piston seat which is sealed off by means of a seal 14. The seal 14 is pressure-balanced relative to the fluid inlet 16 by means of a pressure equalization bore 17.

The first partial piston 8 of the control piston is movable in fluid-tight fashion in the housing 1 of the constant-pressure valve 45 by means of a seal 10.

The second partial piston 3 is preloaded by means of a pressure spring 9. In the state in FIG. 1, the first and second partial pistons 8, 3 are situated in a retracted position relative to one another. The second partial piston 3 is held in the retracted position relative to the first partial piston 8 by means of the fluid pressure in the switching chamber 4a.

The housing 1 has a recess 19 which a securing element 21 engages. The securing element 21 is furthermore received in a recess 18 of the first partial piston 8 and is radially movable within said recess. The recess 18 is delimited by a piston rod 20 of the second partial piston 3. A first axial portion 20a of the partial piston 20 (FIG. 2) holds the securing element 21 in the position shown, such that the securing element 21 produces positive locking between the first partial piston 8 and the housing 1 and absorbs the forces that are exerted on the control piston 8, 3 at the first piston surface S₁ from the side of the fluid inlet.

The recess 19 has a lower edge 13, in contact with the securing element 21, and an upper edge 6.

On the side of the second partial piston 3, in the region of the piston head of the housing 1, a ventilation port 12 is provided for facilitating a piston stroke of the second partial piston 3 relative to the first partial piston 8.

The comparison of FIG. 1 with FIG. 2 shows the functioning of the constant-pressure valve according to the invention. If the fluid pressure in the switching chamber 4a falls, then at a predetermined point, the force acting on the second piston surface S₂ is no longer high enough to hold the second partial piston 3 in the retracted position relative to the first partial piston 8. The second partial piston 3, driven by the pressure spring 9, deflects in the direction of an extended position.

This has the result that the first axial portion 20a of the piston rod 20, which initially delimited the recess 18 in the first partial piston, is no longer aligned with the recess 18, but rather the second axial portion 20b, and in an intervening time optionally a transition portion 20c with a narrowed portion, for example conically narrowed portion, is aligned with the recess 18 of the first partial piston 8 in the position shown in FIG. 2.

The space hereby gained makes it possible for the securing element 21 to deflect radially inward in the recess 18 and to thus eliminate the positive locking between the securing element 21 and the recess 19 of the housing 1. As soon as this has occurred, the forces that act on the first piston surface Si of the control piston are no longer dissipated into the housing, but rather have the effect that the entire control piston is displaced from the standby position as per FIG. 1 into the triggering position as per FIG. 2. The transmission of force from the first partial piston 8 to the second partial piston 3 is ensured either by means of the pressure spring 9 or by means of the securing element 21.

In the triggering position of the control piston 3, 8 as illustrated in FIG. 2, fluid can flow from the fluid inlet 16 to fluid outlet 15. Only when the switching pressure in the switching chamber 4a is again high enough to compress the pressure spring 9 is the second partial piston 3 pushed with the piston rod 20 into the first partial piston 8, which ends initially in a downward movement of the entire control piston 3, 8 and subsequently in a displacement movement of the securing elements into the recess 19. The assumption of the standby position again after a triggering event, which in practice is associated with a fire, will however not be a process that occurs frequently. At any rate, for the renewed loading of the control piston into the standby position, it is to be assumed that the fluid pressure on the side of the fluid inlet 16 is sufficiently low.

FIGS. 3 and 4 show further details relating to the balance of forces with regard to the securing element 21:

FIG. 3 shows, in more detail, the force situation with regard to the securing element 21 in the standby position of the control piston 3, 8 as per FIG. 1. The securing element 21 projects partially out of the recess 18 of the first partial piston 8 and into the recess 19 of the housing 1, whereby positive locking is produced between the securing element 21, the first partial piston 8 and the housing 1. The first partial piston 8 presses, at a contact point P, against the securing element 21, which in turn presses against an edge 6 of the recess 19 in the housing 1. At the point of contact between the securing element 21 and the edge 6, an opposing force F_{G} acts on the securing element in the direction of a surface normal of the securing element 21, which opposing force has an axial component (in relation to the longitudinal axis of the control piston 3, 8) and a radial force component. The surface normal in which the vector F_{G} lies encloses a contact angle a with the longitudinal axis of the control piston 8, 3. The thrust force exerted by the first partial piston 8 in the longitudinal direction Fₚₑ corresponds to the vertical force component of F_{G}, that is to say Fₚₑ=F_{G}*cos α, whilst a radial force component Fₖ additionally arises owing to the contact angle α, specifically Fₖ=F_{G}*sin α is equal to the force with which the securing element 21 is pressed against the first partial piston 3 at the contact point k.

Determined by the friction coefficients between the securing element 21 and the surface of the second partial piston 3 at the point k, FIG. 4 illustrates the friction force Fᵣ=μ* Fₖ.

As soon as the fluid pressure in the switching chamber 4a drops to a sufficiently great extent, it is possible for the pressure spring 9 to overcome the static friction Fᵣ and the opposing force acting on the second partial piston 8 at the second piston surface S₂ that is acted on with P₂, and to displace the second partial piston 3 relative to the first partial piston 8. In this way, the first axial portion 20a is moved out of the range of the recess 18 in the first partial piston, and the balls can firstly slide along the transition portion 20c, before they come into contact with the second axial portion 20b. In this portion, the balls have slid completely out of the recess 19 in the housing 1, such that the first partial piston 8 is no longer held in the standby position as per FIG. 1, but can rather be displaced into the triggering position as per FIG. 2.

The greater the number of securing elements 21 that are arranged in the control piston 3, 8 so as to be distributed over the circumference, the lower are the individual forces on each individual securing element 21, and the lower is the contact pressure acting thereon.

With the functional principle of the constant-pressure valve 43 emerging from the preceding figures, the functioning of the alarm valve station 100 according to the invention and of the sprinkler system 200 according to the invention will finally be discussed. FIG. 5 provides information in this regard. FIG. 5 shows a sprinkler system 200 with an alarm valve station 100 formed as a dry alarm valve station. The alarm valve station 100 has a constant-pressure valve 45 as per FIGS. 1 to 4 and an alarm valve 25 formed as a dry alarm valve.

The dry alarm valve 25 has a housing 30, in which an extinguishing fluid inlet 36 and an extinguishing fluid outlet 37 are formed. The extinguishing fluid inlet 36 and extinguishing fluid outlet 37 are separated from one another by means of a valve body 35 in a shut-off position, and are connected to one another in fluid-conducting fashion in a triggering position. The valve body 35 is controlled by a locking device 40. The locking device 40 has a locking element 42, preferably in the form of a locking lever, and a second control piston 41, which is operatively coupled to the first control piston 3, 8 of the constant-pressure valve 45 via a piston space 44 and a control line 46.

A pressure spring 43 assists the second control piston 41 in an opening direction (on the right in FIG. 5). A throttle 50 is provided in the control line 46 upstream of the first and second control pistons. The control line 46 opens into the inlet side of the alarm valve 25 and is fed, together with the fluid inlet 36, by a water supply line 32.

The outlet side of the alarm valve 25 is connected to a pipeline network 31 which has a number of sprinklers 34. The pipeline network 31 is pneumatically pressurized by means of an air infeed 33.

The valve body 35 of the alarm valve 25 has a first piston area A₁ on the inlet side and a second piston area A₂ on the outlet side. The piston areas A₁ and A₂ are preferably equal. As emerges from the considerations below, it is however no longer of any significant technical importance how large the area ratios between the two piston areas A₁ and A₂ are.

Extinguishing fluid at a pressure P₁ prevails on the inlet side of the alarm valve 25. The same pressure also prevails, via the control line 46, in the piston chamber 44 and at the fluid inlet 16 of the constant-pressure valve 45. At the outlet side, a pneumatic pressure P₂, in particular air pressure, prevails at the alarm valve 25 and in the pipeline network 31. Said pneumatic pressure also prevails, via the pipeline network 31, in the switching chamber 4a of the constant-pressure valve 45. As long as P₂ is above the predetermined switching pressure value of the constant-pressure valve, the constant-pressure valve 25 holds the control piston 3, 8 in the standby position as per FIG. 5, whereby the pressure P₁ is maintained in the piston space 44. H, which also prevails in the water supply line 32, is high enough to hold the piston 41 in the closed position counter to the pressure spring 43 and to hold the valve body 35 in the closed position by means of the locking element 42. If the pressure P₂ on the side of the switching chamber 4a now falls, for example owing to an opening of the sprinklers 34 after detection of a fire, then, at a certain point, the predetermined switching pressure value is reached, at which, in accordance with the mechanism illustrated in FIGS. 1 and 2, the first partial piston 8 and the second partial piston 3 assume the extended position relative to one another, which results in a movement, which is then permitted by P₁, of the control piston 3, 8 into the position as per FIG. 2. As soon as a fluid-conducting connection has been produced between the fluid inlet 16 and the fluid outlet 15 of the constant-pressure valve 45, the control line 46 is relieved of pressure. Water present in said control line flows out through the fluid outlet 15, and is prevented from flowing back by the throttle 50, such that the pressure in the piston space 44 falls. If the pressure in the piston space 44 drops far enough, the spring 43 pushes the locking element 42 out of its locking position into a release position, in which the valve body 35 of the alarm valve snaps open and fluidically connects the extinguishing fluid inlet 36 to the extinguishing fluid outlet 37, whereupon extinguishing fluid can ingress into the pipeline network 31 and flow out of the sprinklers 34.

As is clearly evident from the explanations above, the triggering of the alarm valve 25 functions entirely independently of the pressure P₁ and of the ratio of pressure P₂ to pressure P₁. It is of importance only whether the pressure P₂ lies above the predetermined switching pressure value, which results in a triggering of the constant-pressure valve 45. This permits the installation of an alarm valve 25 which is of very simple construction, and, in relatively tall buildings with large height differences, substantially uniform hardware on all storeys with regard to the alarm valve and the constant-pressure valves. In each case only possibly the pressure spring 9 of the constant-pressure valve has to be exchanged in accordance with the respectively required desired switching threshold or the required switching pressure value that is to be attained for triggering. The pressure difference in the pipeline network 31 however does not fluctuate as intensely as in a liquid-filled pipeline network that extends over multiple storeys, because the density and thus air column vary much less dramatically.

### LIST OF REFERENCE DESIGNATIONS

1 Housing of constant-pressure valve

### 2 Cover

3 Control piston (second partial piston)
4 Switching pressure inlet
4a Switching chamber

### 5 Diaphragm

6 Edge (housing)
7 Input connector
8 Control piston (first partial piston)
9 Spring element
12 Ventilation bore

### 14 Seal

15 Control pressure outlet, fluid outlet of constant-pressure valve
16 Control pressure inlet, fluid inlet of constant-pressure valve
17 Bore for pressure equalization
18 Recess (first partial piston)
19 Recess (housing)
20a First axial portion (second partial piston)
20b Second axial portion (second partial piston)
20c Transition portion
21 Securing element(s)
25 Alarm valve

### 30 Housing

31 Pipeline network
32 Water supply line
33 Air infeed

### 34 Sprinkler

35 Valve body
36 Extinguishing fluid inlet
37 Extinguishing fluid outlet
40 Locking device
41 Control piston (second)
42 Locking element

### 43 Spring

44 Piston space
45 Constant-pressure valve
46 Control line

### 50 Throttle

A₁, A₂ Effective surfaces of valve body 35
S₁, S₂ Piston surfaces of control piston 3
P₁, P₂ Pressures

1. Constant-pressure valve for an alarm valve station of a sprinkler system, having
a fluid inlet, a fluid outlet, a flow channel between the fluid inlet and the fluid outlet,
a control piston which is arranged in the flow channel and which is movable back and forth between a standby position and a triggering position and which has a first piston surface facing toward the flow channel and has a second piston surface,
wherein the constant-pressure valve has a switching chamber which is separate from the flow channel and which has a switching pressure inlet in fluid communication with the switching chamber, wherein the second piston surface faces toward the switching chamber,
wherein the constant-pressure valve has a securing element which is coupled to the control piston of the constant-pressure valve and which, in the standby position, absorbs the forces acting on the first piston surface of the control piston.

2. The constant-pressure valve as claimed in claim 1, wherein the securing element is configured to hold the control piston of the constant-pressure valve in the standby position until a pressure acting on the second piston surface drops to a predetermined switching pressure value.

3. The constant-pressure valve as claimed in claim 2, having a housing in which the control piston is arranged so as to be movable in guided fashion, wherein the housing has a recess which the securing element engages in the standby position of the control piston.

4. The constant-pressure valve as claimed in claim 3, wherein the control piston, in the standby position, holds the securing element in the recess and, when the pressure in the pressure chamber reaches or drops below the switching pressure value, permits a deflection of the securing element out of the recess.

5. The constant-pressure valve as claimed in claim 4, wherein the control piston has a first partial piston and a second partial piston which is longitudinally movable relative to the first partial piston, wherein the first partial piston has the first piston surface, and the second partial piston has the second piston surface.

6. The constant-pressure valve as claimed in claim 5, wherein the first and second partial pistons are coupled such that, when the pressure in the pressure chamber exceeds the switching pressure value, said partial pistons are arranged in a retracted position with respect to one another and, when the pressure in the pressure chamber reaches or drops below the switching pressure value, said partial pistons are arranged in an extended position relative to one another.

7. The constant-pressure valve as claimed in claim 5, wherein the first partial piston has a recess in which the securing element is arranged, and the second partial piston delimits the recess in the retracted position such that the securing element projects into the recess, and in the extended position permits a deflection of the securing element out of the recess.

8. The constant-pressure valve as claimed in claim 5, wherein the securing element, in the retracted position of the first and second partial pistons, is in contact with an edge of the recess, and at the point of contact has a surface normal which, relative to the longitudinal axis of the control piston, has a contact angle in a range between 1° and 30°.

9. The constant-pressure valve as claimed in claim 7, wherein the second partial piston has a piston rod which is movable in guided fashion in a recess of the first partial piston, and also has
a first axial portion with a first diameter, and a second axial portion with a second diameter which is smaller than the first diameter.

10. The constant-pressure valve as claimed in claim 9, wherein the partial pistons are coupled such that the first axial portion of the piston rod is aligned with the recess of the first partial piston when the partial pistons are arranged in the retracted position relative to one another, and the second axial portion of the piston rod is aligned with the recess of the first partial piston when the partial pistons are arranged in the extended position relative to one another.

11. The constant-pressure valve as claimed in claim 1, wherein the securing element is formed as a number of balls, pins, disks or rings, and wherein the recess in the first partial piston is formed as a corresponding number of recesses, in which the number of balls, pins, disks or rings is arranged in radially movable fashion.

12. The constant-pressure valve as claimed in claim 1, wherein the second partial piston is coupled to a pressure spring which forces the second partial piston towards the extended position.

13. The constant-pressure valve as claimed in claim 12, wherein the spring force of the pressure spring in the retracted position of the partial pistons is substantially equal to the force that acts on the second piston surface when the pressure in the switching chamber is at the switching pressure value.

14. The constant-pressure valve as claimed in claim 1, wherein, in the switching chamber, there is arranged a diaphragm which is configured for sealing off the switching chamber and for transmitting force to the second piston surface.

15. An alarm valve station for a sprinkler system, which has a water supply line and a pressurized pipeline network with a number of sprinklers, having an alarm valve, wherein the alarm valve has an extinguishing fluid inlet, an extinguishing fluid outlet and a valve body which is movable back and forth between a shut-off position and an opened-up position, wherein the alarm valve station has a constant-pressure valve which is designed as claimed in claim 14.

16. The alarm valve station as claimed in claim 15, wherein the constant-pressure valve has
a control piston which is movable back and forth between a standby position and a triggering position, and
a switching pressure inlet which, in the shut-off position of the valve body of the alarm valve, is independent of the water supply line, wherein
the control piston is operatively coupled to the valve body of the alarm valve such as, in the standby position, to lock the valve body of the alarm valve in the shut-off position and to release said valve body in the triggering position, and
the constant-pressure valve is configured to hold the control piston in the standby position if the pressure at the switching pressure inlet lies above a predetermined switching pressure value.

17. The alarm valve station as claimed in claim 15, wherein the switching pressure inlet is configured for connection to the pressurized pipeline system, wherein the fluid pressure prevailing at the switching pressure inlet acts on the control piston of the constant-pressure valve in the direction of the standby position.

18. The alarm valve station as claimed in claim 15, wherein the alarm valve has a locking element to which the control piston is operatively coupled at least in the standby position.

19. The alarm valve station as claimed in claim 18, wherein the locking element is formed as a locking lever which is arranged pivotably in the alarm valve and which, at least in the standby position, is mechanically connected to the valve body.

20. The alarm valve station (100) as claimed in claim 18, wherein the control piston of the constant-pressure valve is a first control piston, and the locking element is coupled to a second control piston, wherein the first control piston and the second control piston are operatively coupled to one another by a control line.

21. The alarm valve station as claimed in claim 20, wherein the control line is in fluid communication with the water supply line and/or to the extinguishing fluid inlet of the alarm valve.

22. The alarm valve station as claimed in claim 15, wherein the constant-pressure valve has a fluid outlet as control pressure outlet, and the control piston of the constant-pressure valve is arranged such that, in the standby position, the control pressure outlet and the control line are separated from one another, and in the triggering position, said control pressure outlet and control line are connected to one another in fluid-conducting fashion.

23. The alarm valve station as claimed claim 20, wherein a throttle is arranged in the control line upstream of the first control piston and of the second control piston.

24. A sprinkler system, having
a water supply line,
a pressurized pipeline network with a number of sprinklers, and an alarm valve station with an alarm valve, which alarm valve has an extinguishing fluid inlet connected to the water supply line, an extinguishing fluid outlet connected to the pressurized pipeline network, and a valve body which is movable back and forth between a shut-off position and an opened-up position, wherein, in the shut-off position, the extinguishing fluid inlet and the extinguishing fluid outlet are separated from one another, and in the opened-up position, the extinguishing fluid inlet and the extinguisher fluid outlet communicate with one another in fluid-conducting fashion,
wherein the alarm valve station is designed as claimed in claim 15.
